(19) United States
(12) Patent Application Publication
(10) Pub. No.: US 2019/0352847 A1
(43) Pub. Date: Nov. 21, 2019

(54) TEXTILE PRINTING PAPER FOR USE IN PAPER PRINTING METHOD

(71) Applicant: MITSUBISHI PAPER MILLS LIMITED, Sumida-ku, Tokyo (JP)

(72) Inventor: Shinichiro Matsumoto, Sumida-ku (JP)

(21) Appl. No.: 16/476,997

(22) PCT Filed: Jan. 9, 2018
(86) PCT No.: PCT/JP2018/000182

§ 371 Date: Jul. 10, 2019

(30) Foreign Application Priority Data
Jan. 25, 2017 (JP) 2017-011031

(51) Int. Cl. D06P 5/24; D06P 5/30; D06P 1/00; B41M 5/50

(52) U.S. Cl. CPC D06P 5/008; D06P 5/30; D06P 3/605; B41M 5/502; D06P 1/0052

(57) ABSTRACT

Provided is a textile printing paper for use in a paper printing method, which textile printing paper has an ability to produce a high-resolution image and enables favorable color development on a printing substrate and is excellent in adhesiveness of a printed paper to a printing substrate. The textile printing paper has a base sheet and a glue layer on a surface of the base sheet, the base sheet having a compression layer on at least a glue layer side, the compression layer at least comprising a pigment and a binder, wherein the base sheet has a compression ratio of 1.5 or more as calculated by the formula given below from the smoothness measured using a soft backing at clamp air supply pressures of 300 kPa and 2000 kPa according to JIS P 8151:2004.

Compression ratio=[smoothness of base sheet at 300 kPa]/[smoothness of base sheet at 2000 kPa]

### TECHNICAL FIELD

The present invention relates to a textile printing paper for use in a printing method for depicting a design on a printing substrate such as textile and leather materials, the textile printing paper being used for transferring a design in the printing method. In particular, the present invention relates to a textile printing paper suitable for use in a paper printing method.

### BACKGROUND ART

One of the methods for depicting a high-resolution design fastly on textile and leather materials etc. with a dye is a printing method. The printing method is roughly classified as a method involving platemaking or a method not involving platemaking.

Known printing methods involving platemaking include screen printing, roller printing, rotary screen printing, gravure printing and others using these printing techniques, and these methods have been industrially applied. However, in the printing method involving platemaking, the number of colors that can be used is limited due to platemaking. Particularly, in a printing method involving platemaking based on the RGB tricolor separation, although multiple colors can be expressed, there are problems typified by the following.

(a) It is difficult to adjust the hues and densities of the RGB tricolor components.
(b) The reproducibility of print processing results is poor due to multi-layered printing.
(c) Platemaking is costly for small lot production.
(d) It is necessary to prepare color pastes in excess amounts that are more than actually necessary for print processing.

A solution to the above-described problems is a printing method not involving platemaking. In this printing method, a design is printed on a printing substrate using computer-based image processing and formation technologies etc., for example, by ink jet printing with water-based dye inks. The printing method not involving platemaking is classified as a direct printing method, which is characterized by printing a design directly on a printing substrate, or a transfer printing method, which is characterized by printing a design on a paper called a textile printing paper or a transfer paper, followed by transferring the design printed on the paper to a printing substrate.

Also, a novel advantageous transfer printing method (hereinafter referred to as “paper printing method”) is publicly known (see, for example, Patent Literature 1) and characterized in that a textile printing paper has no need for an expensive release agent or layer, the textile printing paper can easily be released, a post-printing water washing step produces little water pollution, and the resolution, fastness and color development of a printed design are excellent. The paper printing method described in Patent Literature 1 comprises

a step comprising applying a mixed paste of a water-soluble synthetic binder, a natural glue and an auxiliary agent onto a base paper, drying the mixed paste to prepare a textile printing paper, and printing a dye ink on the textile printing paper to prepare a printed paper;

a step comprising bringing the printed paper into close contact with a printing substrate and sticking them together under pressure and heat; and

a step comprising performing dye fixing treatment in such a state that the printed paper is kept stuck to the printing substrate, and then removing the printed paper.

The textile printing paper used in the paper printing method described in Patent Literature 1 can be obtained by applying a mixed paste of a water-soluble synthetic binder, a natural glue and an auxiliary agent onto a base paper and drying the mixed paste.

### CITATION LIST

### Patent Literature

Patent Literature 1: Japanese Patent No. 4778124

### SUMMARY OF INVENTION

### Technical Problem

Textile printing papers for use in the paper printing method are generally required to have the following qualities.

(1) After an image is printed on a blank textile printing paper, the image on the printed paper should be transferred with high resolution on a printing substrate. That is, “an ability to produce a high-resolution image” is required in terms of demand for image quality.
(2) After an image is printed on a blank textile printing paper, the image on the printed paper should be transferred with dense colors on a printing substrate. That is, “color developing ability” is required in terms of demand for image quality.
(3) In the paper printing method, while a printed paper is kept in close contact with a printing substrate, dye fixing treatment, for example, steaming, heating after humid or moist exposure, or dry heating at high temperature, is performed. If the adhesion of the printed paper to the printing substrate is insufficient during the fixing treatment, color unevenness may occur in a solid printed area in which colors are supposed to be evenly transferred. The adhesion of the printed paper to the printing substrate should be enough to prevent such color unevenness, that is, “adhesiveness” is required.

However, Patent Literature 1 does not fully discuss the properties of the base paper of the disclosed textile printing paper, and this textile printing paper does not necessarily satisfy the qualities required for the paper printing method.

An object of the present invention is to provide a textile printing paper for use in a paper printing method, the textile printing paper having the desirable qualities (1) to (3) described above, i.e., an ability to produce a high-resolution image, color developing ability, and adhesiveness.

### Solution to Problem

The present inventor conducted intensive research to achieve the above-described object. As a result, the present inventor found that the above-described object can be achieved by a textile printing paper having a base sheet and a glue layer on a surface of the base sheet, the base sheet having a compression layer on at least a glue layer side, the compression layer at least comprising a pigment and a binder, wherein the base sheet has a compression ratio of 1.5 or more as calculated by a particular formula from the smoothness measured using a soft backing at clamp air supply pressures of 300 kPa and 2000 kPa according to JIS P 8151:2004. The present inventor further conducted intensive research and then completed the present invention.

That is, the present invention relates to the following.

[1] A textile printing paper for use in a paper printing method involving performing dye fixing treatment in such a state that a printed paper is in close contact with a printing substrate, the textile printing paper having a base sheet and a glue layer on a surface of the base sheet, the base sheet having a compression layer on at least a glue layer side, the compression layer at least comprising a pigment and a binder, wherein the base sheet has a compression ratio of 1.5 or more as calculated by the formula given below from the smoothness measured using a soft backing at clamp air supply pressures of 300 kPa and 2000 kPa according to JIS P 8151:2004.

Compression ratio=[smoothness of base sheet at 300 kPa]/[smoothness of base sheet at 2000 kPa]

The textile printing paper of the above [1] is excellent in an ability to produce a high-resolution image, color developing ability and adhesiveness.

[2] The textile printing paper according to the above [1], wherein the pigment in the compression layer comprises at least one component selected from the group consisting of synthetic amorphous silica, calcined kaolin and hollow plastic pigment.

The textile printing paper of the above [2] is more excellent in an ability to produce a high-resolution image, color developing ability or adhesiveness.

[3] The textile printing paper according to the above [1] or [2], wherein the proportion of the binder to the pigment in the compression layer is 30% by mass or less.

The textile printing paper of the above [3] is more excellent in an ability to produce a high-resolution image, color developing ability or adhesiveness.

[4] The textile printing paper according to the above [1], wherein the pigment in the compression layer comprises at least one component selected from the group consisting of synthetic amorphous silica, calcined kaolin and hollow plastic pigment, the total proportion of the at least one component in the pigment is 50% by mass or more, and the proportion of the binder to the pigment is 30% by mass or less.

The textile printing paper of the above [4] is more excellent in an ability to produce a high-resolution image, color developing ability or adhesiveness.

[5] The textile printing paper according to the above [1], wherein the pigment in the compression layer comprises at least one component selected from the group consisting of calcined kaolin and hollow plastic pigment, the total proportion of the at least one component in the pigment is 60% by mass or more, and the proportion of the binder to the pigment is 30% by mass or less.

The textile printing paper of the above [5] is more excellent in an ability to produce a high-resolution image, color developing ability or adhesiveness.

Advantageous Effects of Invention

The present invention provides a textile printing paper for use in a paper printing method, which textile printing paper has an ability to produce a high-resolution image and enables favorable color development on a printing substrate and is excellent in adhesiveness during dye fixing treatment.

### DESCRIPTION OF EMBODIMENTS

Hereinafter, the present invention will be described in detail.

In the present invention, the “textile printing paper” refers to a blank sheet of paper which is for use in a paper printing method and yet to be subjected to printing of an image to be transferred. The “printed paper” refers to a printed sheet of paper, more specifically a textile printing paper having been subjected to printing of an image to be transferred. Hereinafter, a textile printing paper for use in a paper printing method is referred to simply as a “textile printing paper”.

In the present invention, the paper printing method refers to the transfer printing method described in Patent Literature 1. More specifically, the paper printing method is a transfer printing method comprising:

a step comprising applying a glue layer coating composition consisting of a water-soluble synthetic binder, a natural glue and an auxiliary agent onto a surface of a base sheet, and drying the coating composition to prepare a textile printing paper;

a step of printing an image on the textile printing paper with a dye ink to prepare a printed paper;

a step comprising bringing the printed paper into close contact with a printing substrate and sticking them together under heat and pressure; and

a step comprising performing dye fixing treatment in such a state that the printed paper is kept stuck to the printing substrate, and then removing the printed paper.

In the present invention, the textile printing paper has a base sheet and a glue layer on a surface of the base sheet, the base sheet having a compression layer on at least a glue layer side, the compression layer at least comprising a pigment and a binder, wherein the base sheet has a compression ratio of 1.5 or more as calculated by the formula given below from the smoothness measured using a soft backing at clamp air supply pressures of 300 kPa and 2000 kPa according to JIS P 8151:2004. JIS P 8151:2004 specifies “Paper and board—Determination of roughness/smoothness (air leak methods)—Print-surf method” (ISO 8791-4:1992 “Paper and board—Determination of roughness/smoothness (air leak methods)—Part 4: Print-surf method”), and the compression ratio is a value determined by dividing the smoothness measured at an air supply pressure of 300 kPa according to the above method by the smoothness similarly measured at an air supply pressure of 2000 kPa.

Compression ratio=[smoothness of base sheet at 300 kPa]/[smoothness of base sheet at 2000 kPa]

When the compression ratio is less than 1.5, the ability to produce a high-resolution image, color developing ability or adhesiveness is reduced. The compression ratio is preferably 2.5 or more. The reason is unclear, but one plausible speculation is as follows. A printing substrate, in particular, a textile material has a less smooth surface, and therefore, the printed paper is required to flexibly change in shape to fit and adhere to the surface of the printing substrate. When the compression ratio of the compression layer in the base sheet is 1.5 or more, a combination of the base sheet and the glue layer specified in the present invention works so effectively that the printed paper can fit and adhere well to the surface of the printing substrate.

The compression ratio of the base sheet can be adjusted to 1.5 or more without a compression layer by, for example, using a low-density paper substrate (the term “paper substrate” will be described later) for the base sheet. However, when the base sheet has only a paper substrate without a compression layer, the paper substrate excessively changes in shape and misfits to the surface of the printing substrate. As a result, the paper substrate fails to adhere well to the surface of the printing substrate, thereby causing adverse effects on the ability to produce a high-resolution image, color developing ability or adhesiveness. The upper limit of the compression ratio is not particularly specified, but a compression ratio of 4.0 or less is preferable in terms of easy handling of paper.

Due to the synergistic effect of a combination of the compression ratio of the base sheet specified in the present invention and the glue layer specified in the present invention, the textile printing paper of the present invention is excellent in an ability to produce a high-resolution image, color developing ability and adhesiveness. The reason is unclear, but one plausible speculation is as follows. The base sheet specified in the present invention allows the textile printing paper to change in shape to fit to the surface of a printing substrate. Therefore, with a combination of the base sheet and the glue layer specified in the present invention, the printed paper can adhere to the surface of the printing substrate under an almost even force in the step comprising bringing the printed paper into close contact with the printing substrate and sticking them together under heat and pressure. This contributes to the advantages described above.

The base sheet of the present invention is composed of a paper substrate and a compression layer. The base sheet has a compression layer on at least one surface of the paper substrate. On the compression layer, a glue layer is provided. That is, the textile printing paper has a compression layer between the glue layer and the paper substrate. The base sheet may have compression layers on both surfaces of the paper substrate.

The paper substrate is usually a base paper produced by blending a chemical pulp such as LBKP (Leaf Bleached Kraft Pulp) and NBKP (Needle Bleached Kraft Pulp), a mechanical pulp such as GP (Groundwood Pulp), PGW (Pressure GroundWood pulp), RMP (Refiner Mechanical Pulp), TMP (ThermoMechanical Pulp), CTMP (ChemiThermoMechanical Pulp), CMP (ChemiMechanical Pulp) and CGP (ChemiGroundwood Pulp), or a waste paper pulp such as DIP (DeInked Pulp) with a filler such as precipitated calcium carbonate, ground calcium carbonate, talc, clay and kaolin, and as needed, an additive such as a sizing agent, a fixing agent, a retention aid, a cationizing agent such as a cation resin and a multivalent cation salt, and a paper strengthening agent to prepare a paper stock, rendering the paper stock acidic, neutral or alkaline, and subjecting the paper stock to a papermaking process. The paper substrate may also be, for example, a woodfree paper prepared by subjecting a base paper to calendering, surface sizing with starch, polyvinyl alcohol, etc., surface treatment or other treatments. Further, the paper substrate may also be a woodfree paper prepared by subjecting a base paper to surface sizing or surface treatment, followed by calendering.

The paper stock can contain one or more additional additives such as a pigment dispersant, a thickener, a glidant, a defoamer, an antifoamer, a release agent, a foaming agent, a penetrant, a coloring dye, a coloring pigment, an optical brightener, an ultraviolet absorber, an antioxidant, a preservative, a fungicide, an insolubilizer, a wet strengthening agent and a dry strengthening agent as long as the one or more additional additives do not impair the effects of the present invention.

In the present invention, the compression layer is a coating layer provided so that the base sheet has a compression ratio of 1.5 or more. The components of the compression layer are not particularly limited. The compression ratio can be adjusted by selecting the type of the coater, the drying time and temperature, the presence or absence of calendering and the calendering conditions, the type of the pigment, the binder, etc. in the compression layer and their content ratio, the coating weight, etc. To obtain a compression layer having a relatively high compression ratio, for example, a low-pressure type coater, such as an air knife coater, a curtain coater, a die coater or a slide bead coater, may be used; relatively mild drying conditions may be employed; no or soft calendering may be performed; and the proportion of hollow plastic pigment in the compression layer may be increased.

The compression layer at least comprises a pigment and a binder. Examples of the pigment include known pigments used in the papermaking field including inorganic pigments, such as kaolin, calcined kaolin, clay, ground calcium carbonate, precipitated calcium carbonate, synthetic amorphous silica, aluminum oxide and aluminum hydroxide; and organic pigments, such as hollow plastic pigment, solid plastic pigment, expanded microcapsules and heat-expandable microcapsules. The pigment is one kind or a combination of two or more kinds selected from the group consisting of the foregoing examples. Examples of the binder include known binders used in the papermaking field including polyvinyl-alcohol binders, acrylic binders, urethane binders, polyethylene oxide binders, vinyl acetate binders, polyester binders, polyvinyl acetal binders, styrene-butadiene binders, cellulose derivatives (carboxymethyl cellulose, etherified carboxymethyl cellulose, hydroxyethyl cellulose, etc.), starch derivatives (starch, glycogen, dextrin, amylose, etherified starch, esterified starch, etc.), seaweeds (sodium alginate, agar, etc.), gelatin and casein. The binder is one kind or a combination of two or more kinds selected from the group consisting of the foregoing examples.

The pigment in the compression layer preferably comprises at least one component selected from the group consisting of synthetic amorphous silica, calcined kaolin and hollow plastic pigment. In this case, the improvement in the ability to produce a high-resolution image, color developing ability or adhesiveness is attained. The total proportion of the at least one component selected from the group consisting of synthetic amorphous silica, calcined kaolin and hollow plastic pigment in the pigment in the compression layer is preferably 30% by mass or more, more preferably 50% by mass or more.

In another preferable embodiment regarding the pigment, the pigment in the compression layer comprises at least one component selected from the group consisting of calcined kaolin and hollow plastic pigment, and the total proportion of the at least one component in the pigment in the compression layer is 60% by mass or more. In this case, the improvement in the ability to produce a high-resolution image, color developing ability or adhesiveness is attained.

The hollow plastic pigment is an organic pigment composed of particles made of any of the materials described below, and individual particles have an air layer inside. The hollow ratio (hollow volume/outer solid volume) of the hollow plastic pigment is preferably from 25 vol % to 90 vol %, more preferably from 25 vol % to 80 vol %, and still more preferably from 40 vol % to 65 vol %. The average particle diameter of the hollow plastic pigment is preferably from 0.1 μm to 10 μm. The material of the hollow plastic pigment is preferably polystyrene or a copolymer formed of styrene as a main component with a monomer copolymerized with styrene. Examples of the monomer copolymerized with styrene include acrylic monomers, such as acrylic acid, acrylate ester, methacrylic acid and methacrylate ester; acrylonitrile; butadiene; and isoprene. The material of the hollow plastic pigment is more preferably a polystyrene-based copolymer or a styrene acrylic-based copolymer.

The proportion of the binder to the pigment in the compression layer is preferably 30% by mass or less, and more preferably from 5% by mass to 25% by mass. In this case, the improvement in the ability to produce a high-resolution image, color developing ability or adhesiveness is attained.

In a preferable embodiment regarding the pigment and the binder, the pigment in the compression layer comprises at least one component selected from the group consisting of synthetic amorphous silica, calcined kaolin and hollow plastic pigment, the total proportion of the at least one component in the pigment is 50% by mass or more, and the proportion of the binder to the pigment is 30% by mass or less.

In another preferable embodiment regarding the pigment and the binder, the pigment in the compression layer comprises at least one component selected from the group consisting of calcined kaolin and hollow plastic pigment, the total proportion of the at least one component in the pigment is 60% by mass or more, and the proportion of the binder to the pigment is 30% by mass or less.

The coating weight of a compression layer coating composition is preferably from 3 g/m² to 30 g/m², more preferably from 3 g/m² to 20 g/m², and still more preferably from 3 g/m² to 10 g/m² in terms of dry solids content.

The basis weight of the base sheet is not particularly limited in the present invention. In view of ease of handling in transfer printing, the basis weight is preferably from 10 g/m² to 100 g/m², and more preferably from 40 g/m² to 80 g/m². The thickness of the textile printing paper is also not particularly limited. In view of ease of handling in transfer printing, the thickness of the textile printing paper is preferably from 0.01 mm to 0.5 mm, and more preferably from 0.05 mm to 0.3 mm.

In the present invention, the textile printing paper has a glue layer on a surface of the base sheet. The formation of the glue layer on the surface of the base sheet can be achieved by applying a glue layer coating composition onto the compression layer of the base sheet and subsequent drying the coating composition.

The glue layer refers to a layer which is formed of the components of the glue layer coating composition and is clearly distinguishable from the base sheet by, for example, electron microscopy. The glue layer of the present invention has the function as an ink receiving layer to hold an dye ink to be printed on the textile printing paper; the function as an adhesive layer for strong adhesion of a printed paper to a printing substrate upon the application of heat and pressure on the printed paper in close contact with the printing substrate; and the function as a release layer which becomes less adhesive as a result of dye fixing treatment (e.g., steaming, heating after humid or moist exposure, or dry heating at high temperature).

The coating weight of the glue layer coating composition on the surface of the base sheet is not particularly limited. In view of the production cost of the textile printing paper and the adhesion of the textile printing paper to a printing substrate, the coating weight is preferably from 5 g/m² to 70 g/m², and more preferably from 15 g/m² to 30 g/m² in terms of dry solids content.

The method for the formation of the compression layer and the glue layer on the surface of the base sheet in the present invention is not particularly limited. For example, a known coating apparatus and a known drying apparatus used in the papermaking field can be used for coating and drying. Examples of the coating apparatus include a comma coater, a film press coater, an air knife coater, a rod blade coater, a bar coater, a blade coater, a gravure coater, a curtain coater, a die coater, a slide bead coater and an extrusion bar coater. For the formation of the glue layer, various types of printing techniques, such as lithographic printing, letterpress printing, flexographic printing, gravure printing, screen printing and hotmelt printing, can also be used. Examples of the drying apparatus include various types of dryers such as hot air dryers such as a linear tunnel dryer, an arch dryer, an air loop dryer and a sine curve air floatation dryer; an infrared heat dryer; and a microwave dryer.

The glue layer having the above-described functions preferably contains a water-soluble synthetic binder and a natural glue.

The water-soluble synthetic binder contained in the glue layer is usually soluble in water, has a strong ability to form a coat upon heat application, and becomes less adhesive in humid conditions. The water-soluble synthetic binder used in the present invention is required not to impede fixing treatment, and major examples include petrochemically synthesized water-soluble synthetic binders. In the present invention, the term “water-soluble” means that 1% by mass or more of a solute can be ultimately dissolved or dispersed in water at 20° C.

Examples of the water-soluble synthetic binder include a water-soluble polyvinyl alcohol binder, a water-soluble acrylic binder, a water-soluble urethane binder, a water-soluble urethane-modified ether binder, a water-soluble polyethylene oxide binder, a water-soluble polyamide binder, a water-soluble phenol binder, a water-soluble vinyl acetate binder, a water-soluble styrene/acrylic binder, a water-soluble styrene/maleic acid binder, a water-soluble styrene/acrylic/maleic acid binder, a water-soluble polyester binder, a water-soluble polyvinyl acetal binder, a water-soluble polyester urethane binder, a water-soluble polyether urethane binder and a water-soluble hotmelt adhesive. One kind or a combination of two or more kinds selected from the group consisting of the foregoing examples can be used as the water-soluble synthetic binder. Among these, preferred is at least one kind of water-soluble synthetic binder selected from the group consisting of a water-soluble polyvinyl alcohol binder, a water-soluble acrylic binder, a water-soluble polyester binder, a water-soluble polyether urethane binder and a water-soluble hotmelt adhesive because these water-soluble synthetic binders are excellent in water solubility and temporary adhesiveness (a property meaning that a substance adheres upon heat application but becomes less adhesive in humid conditions) and do not impede fixing treatment.

Examples of the water-soluble hotmelt adhesive include an alkali-soluble hotmelt adhesive composed of a maleic acid-based alternating copolymer, a water-sensitive hotmelt adhesive and a polyvinyl alcohol hotmelt adhesive.

At least one of the water-soluble synthetic binders used is preferably a water-soluble polyester binder having a glass transition temperature of 51° C. or higher. The glass transition temperature of the water-soluble polyester binder is preferably from 51° C. to 100° C., and more preferably from 51° C. to 80° C. This is because the water-soluble polyester binder having a glass transition temperature of 51° C. or higher can prevent uneven coating at the time of the glue layer formation. The prevention of uneven coating results in better ability to produce a high-resolution image on a printing substrate.

In the present invention, the water-soluble polyester binder is a resin that can be obtained by polycondensation of a polycarboxylic acid and a polyol, the total of which accounts for 60% by mass or more of the components of the resin. Examples of the polycarboxylic acid include terephthalic acid, isophthalic acid, phthalic acid, naphthalene dicarboxylic acid, adipic acid, succinic acid, sebacic acid and dodecanedioic acid. Preferably, one or more kinds selected from the group consisting of the foregoing examples are used. Examples of the polyol include ethylene glycol, propylene glycol, 1,4-butanediol, 1,6-hexanediol, neopentylglycol, diethylene glycol, dipropylene glycol, cyclohexanedimethanol and bisphenol. Preferably, one or more kinds selected from the group consisting of the foregoing examples are used. The water-soluble polyester binder may be copolymerized with a component having a hydrophilic group such as a carboxyl group and a sulfonic group for further improvement of water solubility. The glass transition temperature of the water-soluble polyester binder can be adjusted by selecting an appropriate polycarboxylic acid and an appropriate polyol. Alternatively, the water-soluble polyester binder may be copolymerized with another component for the adjustment of the glass transition temperature.

Water-soluble polyester binders are commercially available from Goo Chemical Co., Ltd., Takamatsu Oil & Fat Co., Ltd., Unitika Ltd., etc., and such commercial products can be used in the present invention.

In the present invention, the glass transition temperature can be determined from measurement using a differential scanning calorimeter, for example, EXSTAR 6000 (manufactured by Seiko Instruments Inc.), DSC220C (manufactured by Seiko Instruments Inc.), DSC-7 (manufactured by PerkinElmer, Inc.), or the like, and is defined as the intersection of the baseline and the slope of the endothermic peak.

The natural glue contained in the glue layer is usually an unprocessed or physically- or chemically-processed, naturally-occurring glue material. The natural glue has hydrophilic and adhesive properties. Its adhesive strength does not increase during heat application, and fixing treatment or dry heating facilitates removal of the natural glue. In addition, the natural glue is highly miscible with a dye ink and can uniformly absorb and hold a dye ink.

Natural glues can be classified as animal-derived glues, plant-derived glues or mineral-derived glues. Examples of the animal-derived glue include gelatin, which is extracted from collagen contained in animal skin and bones. Examples of the plant-derived glue include carboxymethyl cellulose, which is obtained by processing cellulose as a starting material and starch. Examples of the mineral-derived glue include clay, which is extracted from clay minerals. More specific examples of the natural glue include natural gums (e.g., etherified tamarind gum, etherified locust bean gum, etherified guar gum, acacia (gum arabic), etc.); cellulose derivatives (e.g., carboxymethyl cellulose, etherified carboxymethyl cellulose, hydroxyethyl cellulose, etc.); starch derivatives (e.g., starch, glycogen, dextrin, amylose, hyaluronic acid, arrowroot starch, konjac starch, potato starch, etherified starch, esterified starch, etc.); seaweeds (e.g., sodium alginate, agar, etc.); mineral-derived glues (e.g., bentonite, aluminum silicate and its derivatives, oxidized silicon including silica, diatomite, clay, kaolin, acid clay, etc.); and animal-derived glues (e.g., casein, gelatin, egg protein, etc.). One kind or a combination of two or more kinds selected from the foregoing examples can be used. Among these natural glues, preferred are natural gums; cellulose derivatives such as carboxymethyl cellulose; starch derivatives such as etherified starch; seaweeds such as sodium alginate; mineral-derived glues such as oxidized silicon, aluminum silicate and clay; animal-derived glues; and the like.

The mass ratio of the water-soluble synthetic binder and the natural glue contained in the glue layer in the present invention is preferably in the range of 95:5 to 20:80 in terms of dry solids content. When the mass ratio of the water-soluble synthetic binder and the natural glue is in this range, the printed paper can more easily be released from the printing substrate after fixing treatment, the color yield of the dye to be transferred is further enhanced, and uneven transfer is prevented.

In the present invention, the glue layer of the textile printing paper can contain an auxiliary agent. The auxiliary agent is intended to, for example, optimize the physical properties of the glue layer coating composition and enhance the color yield of the dye to be transferred. Examples of the auxiliary agent include various types of surfactants, thickeners, moisturizers, wetting agents, pH adjusters, alkaline chemicals, color deepening agents, preservatives, fungicides, degassing agents, defoamants and reduction inhibitors.

The amount of the auxiliary agent contained in the glue layer is, for example, as follows. In the case where an anionic surfactant or the like is added as the auxiliary agent to function as a surface tension depressant or a penetrant, the amount of the auxiliary agent is from 0.2 to 5% by mass relative to the dry solids content of the glue layer. In the case where a moisturizer or a wetting agent, such as polyhydric alcohols such as polyethylene glycol, glycerin, thiodiglycol and diethylene glycol, urea, thiourea and dicyandiamide, is added as the auxiliary agent to enhance the adhesiveness of the printed paper to the printing substrate and to enhance the color yield of the dye, the amount of the auxiliary agent is from 1 to 25% by mass relative to the dry solids content of the glue layer. In the case where a synthetic acrylic thickener is added as the auxiliary agent to stabilize coating, the amount of the auxiliary agent is 3% by mass or less relative to the dry solids content of the glue layer. In the case where a preservative, a fungicide, a defoamant, a degassing agent or a reduction inhibitor is added as the auxiliary agent, the amount of the auxiliary agent is from 0.1 to 5% by mass relative to the dry solids content of the glue layer. In the case where an alkaline chemical, such as soda ash, sodium bicarbonate, sodium silicate and sodium acetate, is used as the auxiliary agent added on the occasion of using a reactive dye, the amount of the auxiliary agent is from 1 to 25% by mass relative to the dry solids content of the glue layer. In the case where a pH adjuster, such as ammonium sulfate and sodium dihydrogenphosphate, is used as the auxiliary agent added on the occasion of using a disperse dye or an acid dye, the amount of the auxiliary agent is from 0.1 to 3% by mass relative to the dry solids content of the glue layer. When the amount of each auxiliary agent relative to the glue is in the above range, preferable effects of the present invention can be obtained.

In the present invention, the printed paper can be prepared by printing an image on the glue layer side of the textile printing paper by a known printing process using a dye ink. The image is made based on a design to be printed. The textile printing paper may have glue layers on both surfaces of the base sheet. This embodiment is preferable because such a textile printing paper can be used without any distinction between the back and front sides of the textile printing paper.

Examples of the printing technique used in the present invention to print an image on the glue layer side of the textile printing paper include gravure printing, ink jet printing and screen printing. Particularly preferred is ink jet printing because of high-resolution image quality and the compactness of the apparatus.

Examples of the dye ink used in the present invention include known dye inks used in transfer printing methods, specifically, dye inks containing dyes such as a reactive dye, an acid dye, a metal complex salt dye, a direct dye, a disperse dye and a cationic dye. The dye ink is prepared by dissolving or dispersing a dye as typified above, and if needed, an additive(s) in a solvent for dyes such as water.

The dye ink for ink jet printing used in the paper printing method is prepared by dissolving or dispersing a dye in, for example, a solvent or dispersant for dyes. Examples of the solvent for dyes include water, thiodiglycol, polyethylene glycol, glycerin, ethylene glycol and ε-caprolactam. If needed, the dye ink may further contain a drying inhibitor, a surface tension modifier, a viscosity modifier, a pH adjuster, a preservative, a fungicide, a chelating agent, a defoamant, a degassing agent and/or the like.

The type of the dye is selected from a reactive dye, a direct dye, an acid dye, a metal complex salt dye, a disperse dye, a cationic dye, etc. according to the type of the printing substrate. In the case where an ink is prepared from a disperse dye, it is preferable to finely ground the disperse dye in a mill using zirconia beads of 0.1 mm to 0.3 mm in size to the extent that the average particle diameter of the disperse dye becomes about 0.1 μm.

In the present invention, the paper printing method is the method described in JP-4778124, which comprises the steps of:

preparing a textile printing paper,

preparing a printed paper,

bringing the printed paper into close contact with a printing substrate,

performing dye fixing treatment in such a state that the printed paper is in close contact with the printing substrate, and

removing the printed paper.

In the present invention, the above-mentioned close contact step comprises heating and pressurization. After the close contact of the printed paper with the printing substrate, dye fixing treatment is performed while the close contact is maintained. The conditions of the heating and pressurization in the above-mentioned close contact step may be the same as those used in known transfer printing methods. For example, a heating drum or the like is used for bringing the printed paper into close contact with a printing substrate followed by heat and pressure application.

In the present invention, the paper printing method comprises the step of performing dye fixing treatment in such a state that the printed paper is in close contact with the printing substrate. Examples of the dye fixing treatment include steaming as commonly used in printing using a reactive dye etc., and heating after humid or moist exposure. In the case where the printing substrate is made of polyester fibers or other synthetic fibers, dry heating may be employed. Steaming or heating after humid or moist exposure renders the printed paper releasable. In the case where the printing substrate is made of polyester fibers or other synthetic fibers, dry heating may render the printed paper releasable, but preferably, moist exposure is performed after dry heating for easier release of the printed paper.

In the present invention, the conditions of the dye fixing treatment performed in such a state that the printed paper is in close contact with the printing substrate may be the same as those of steam fixation of dyes used in known direct printing methods. For example, steam at 100 to 220° C. is applied from the non-printed side of the printed paper. In the case where the dye is a reactive dye, steaming can be performed at 100 to 105° C. for 5 to 20 minutes as in single-phase steam fixing. In the case where the glue layer contains no alkaline chemicals, the same steaming conditions as used in two-phase steam fixing (for example, cold fixing etc.) can be employed. In the case where the dye is an acid dye, steaming can be performed at 100 to 105° C. for 10 to 30 minutes. Such a moist or humid exposure by steaming makes it easy to release the printed paper from the printing substrate. In the case where the dye is a disperse dye, HT steaming (high temperature steaming) at 160 to 220° C. for 1 to 15 minutes or dry heating can be performed. Dry heating may render the printed paper releasable, but preferably, the printed paper is exposed to a small amount of humidity or moisture after dry heating for easier release of the printed paper.

In the present invention, the dye fixing treatment may be performed after or at the same time as the heating and pressurization in the step of bringing the printed paper into close contact with a printing substrate. The printed paper is brought into close contact with the printing substrate, heating and pressurization and dye fixing treatment are performed, and as a result, the dye in the dye ink printed on the textile printing paper is transferred and bonded to the printing substrate. The dye fixing treatment results in not only the fixation of the dye bonded to the printing substrate, but also the reduction of the adhesive strength between the printed paper and the printing substrate.

After the fixing treatment, the printed paper is released from the printing substrate, and the printing substrate may be subjected to a known washing treatment used in the dye printing field, such as water washing and soaping. For example, in the case of using a disperse dye, the washing procedure is made up of water washing, reduction cleaning and water washing in this order; and in the case of using other dyes, the washing procedure is made up of water washing, soaping and water washing in this order. After water washing, a dyed printing substrate having a good texture as well as a high-resolution and densely-colored image can be obtained. In the case where the dye is a disperse dye or the printing substrate is made of synthetic fibers such as polyester, even if washing is not performed, a dyed printing substrate having a good texture as well as a high-resolution and densely-colored image can be obtained.

In the present invention, the printing substrate is, for example, a textile or leather material, but is not limited thereto. The textile material may be a natural fiber material or a synthetic fiber material. Examples of the natural fiber material include cellulosic fiber materials such as cotton, linen, lyocell, rayon and acetate; and protein fiber materials such as silk, wool and other animal hairs. Examples of the synthetic fiber material include a polyamide fiber (nylon), vinylon, polyester and polyacrylic. Examples of the leather material include natural leathers derived from cattle, water buffalos, pigs, horses, sheep, goats, kangaroos, deer, leopards, rabbits, foxes and camels; and dry processed leathers obtained by a known tanning process and/or other leather production processes.

In the present invention, the textile or leather material can be in the form of a woven fabric, a knit fabric, a non-woven fabric, a leather or the like from a single yarn, a blended yarn, a combined filament yarn, two different yarns or the like.

Moreover, the textile or leather material may be in a composite form of the foregoing. In addition, if needed, the printing substrate may be pretreated with chemicals which affect the color yield of the dye or chemicals which enhance the color yield of the dye. For example, in the case where a reactive dye is used, the printing substrate may be pretreated with a pretreatment liquid containing 3 to 15% by mass of an alkaline chemical such as sodium carbonate, potassium carbonate, sodium bicarbonate, sodium silicate, sodium acetate, sodium sesquicarbonate and sodium trichloroacetate; 3 to 25% by mass of urea for the prevention of yellowing at the time of printing, the improvement of print results and the enhancement of color yield; and 0.05 to 1% by mass of a hydrophilic thickener, for example, sodium alginate, as a migration inhibitor. In the case where an acid dye is used, the printing substrate may be pretreated with a pretreatment liquid containing 0.5 to 5% by mass of an ammonium salt of an acid such as ammonium sulfate and ammonium tartrate as a color yield enhancer; and 0.05 to 0.5% by mass of an acid-resistant natural gum as a migration inhibitor. However, in the present invention, pretreatment is usually unnecessary.

### EXAMPLES

Hereinafter, the present invention will be described in more detail by examples, but the present invention is not limited thereto. Various alterations and modifications can be made without departing from the technical scope of the present invention. In the Examples below, “part” and “%” represent “part by mass” and “% by mass” in terms of dry solids content or the amount of a substantial component, respectively. The coating weight of a glue layer coating composition is expressed as dry solids content.

### Example 1

### Preparation of Base Sheet 1

On a woodfree paper having a basis weight of 77 g/m² and a density of 0.77 g/cm³, the compression layer coating composition 1 shown below was applied with an air knife coater such that the dry solids content would be 10 g/m², and then dried to give base sheet 1. The coating conditions and drying conditions were adjusted to obtain a predetermined compression ratio.

### Preparation of Compression Layer Coating Composition 1

100 parts of precipitated calcium carbonate (Tama Pearl TP-121: manufactured by OKUTAMA KOGYO CO., LTD.), 3 parts of starch (MS4600: manufactured by NIHON SHOKUHIN KAKO CO., LTD.), and 7 parts of a styrene-butadiene binder (E1585: manufactured by Asahi Kasei Chemicals Corporation) were dispersed and mixed with a stirrer in water in such an amount that the concentration of the coating components would be 40%, to give compression layer coating composition 1.

### Preparation of Glue Layer Coating Composition

300 parts of a water-soluble polyester binder (PLAS COAT RZ-142, glass transition temperature: 34° C., manufactured by Goo Chemical Co., Ltd.), 30 parts of polyvinyl alcohol (AP-17, manufactured by JAPAN VAM & POVAL CO., LTD.), 120 parts of etherified starch (Solvitose C-5, manufactured by Avebe), 60 parts of an aluminum silicate derivative (Enbatex D-23, manufactured by KYOEI KAGAKU Co., LTD.), 55 parts of silicon dioxide (MIZUKASIL P-78A, manufactured by Mizusawa Industrial Chemicals, Ltd.), 60 parts of dicyandiamide, 210 parts of soda ash, 90 parts of urea, 60 parts of thiourea, 15 parts of a surfactant (MAC-100S, manufactured by HOKKO CHEMICALS Co., Ltd.) and 930 parts of water were mixed with vigorous stirring using a mixer to prepare a glue layer coating composition.

### Preparation of Textile Printing Paper

Onto the compression layer coating surface of base sheet 1, the above-prepared glue layer coating composition was applied with an air knife coater and then dried to give a textile printing paper. The coating weight of the glue layer coating composition was 20 g/m².

### Preparation of Printed Paper

A test image was printed on the glue layer side of the textile printing paper with an inkjet printer (ValueJet VJ-1324, manufactured by MUTOH INDUSTRIES, Ltd.) using a reactive dye ink (15% C.I. Reactive Blue 19, 5% polyethylene glycol, 5% glycerin, 5% ε-caprolactam and 70% ion exchanged water), a reactive dye ink (10% C.I. Reactive Red 226, 5% polyethylene glycol, 5% glycerin, 5% ε-caprolactam and 75% ion exchanged water) and a reactive dye ink (15% C.I. Reactive Yellow 95, 5% polyethylene glycol, 5% glycerin, 5% ε-caprolactam and 70% ion exchanged water), to give a printed paper (rolled printed paper).

### Textile Printing

Cotton fabric was used as the printing substrate. The printed paper was brought into close contact with a cotton fabric, and heat and pressure were applied (190° C., 0.5 MPa, 2.5 m/min, on a roller) to allow the printed paper to stick to the cotton fabric. With the printed paper being stuck on the cotton fabric, fixing treatment was performed by steaming at 100° C. for 15 minutes for transfer of the dye inks to the cotton fabric. After that, the printed paper was released.

After the release of the printed paper, the cotton fabric was subjected to water washing, soaping, water washing and drying in the usual manner to give a dyed printing substrate (the dyed printing substrate of Example 1).

### Example 2

The dyed printing substrate of Example 2 was obtained in the same manner as described in Example 1 except that the compression layer coating composition 2 shown below was used instead of compression layer coating composition 1.

### Compression Layer Coating Composition 2

80 parts of precipitated calcium carbonate (Tama Pearl TP-121: manufactured by OKUTAMA KOGYO CO., LTD.), 20 parts of synthetic amorphous silica (FINESIL X60: manufactured by Oriental Silicas Corporation), 3 parts of starch (MS4600: manufactured by NIHON SHOKUHIN KAKO CO., LTD.), and 7 parts of a styrene-butadiene binder (E1585: manufactured by Asahi Kasei Chemicals Corporation) were dispersed and mixed with a stirrer in water in such an amount that the concentration of the coating components would be 35%, to give compression layer coating composition 2.

### Example 3

The dyed printing substrate of Example 3 was obtained in the same manner as described in Example 1 except that the compression layer coating composition 3 shown below was used instead of compression layer coating composition 1.

### Compression Layer Coating Composition 3

50 parts of precipitated calcium carbonate (Tama Pearl TP-121: manufactured by OKUTAMA KOGYO CO., LTD.), 25 parts of synthetic amorphous silica (FINESIL X60: manufactured by Oriental Silicas Corporation), 25 parts of hollow plastic pigment (ROPAQUE HP91: manufactured by Dow Coating Materials), 3 parts of starch (MS4600: manufactured by NIHON SHOKUHIN KAKO CO., LTD.), and 7 parts of a styrene-butadiene binder (E1585: manufactured by Asahi Kasei Chemicals Corporation) were dispersed and mixed with a stirrer in water in such an amount that the concentration of the coating components would be 30%, to give compression layer coating composition 3.

### Example 4

The dyed printing substrate of Example 4 was obtained in the same manner as described in Example 1 except that the compression layer coating composition 4 shown below was used instead of compression layer coating composition 1.

### Compression Layer Coating Composition 4

70 parts of precipitated calcium carbonate (Tama Pearl TP-121: manufactured by OKUTAMA KOGYO CO., LTD.), 30 parts of hollow plastic pigment (ROPAQUE HP91: manufactured by Dow Coating Materials), 3 parts of starch (MS4600: manufactured by NIHON SHOKUHIN KAKO CO., LTD.), and 7 parts of a styrene-butadiene binder (E1585: manufactured by Asahi Kasei Chemicals Corporation) were dispersed and mixed with a stirrer in water in such an amount that the concentration of the coating components would be 40%, to give compression layer coating composition 4.

### Example 5

The dyed printing substrate of Example 5 was obtained in the same manner as described in Example 1 except that the compression layer coating composition 5 shown below was used instead of compression layer coating composition 1.

### Compression Layer Coating Composition 5

40 parts of precipitated calcium carbonate (Tama Pearl TP-121: manufactured by OKUTAMA KOGYO CO., LTD.), 60 parts of hollow plastic pigment (ROPAQUE HP91: manufactured by Dow Coating Materials), 3 parts of starch (MS4600: manufactured by NIHON SHOKUHIN KAKO CO., LTD.), and 7 parts of a styrene-butadiene binder (E1585: manufactured by Asahi Kasei Chemicals Corporation) were dispersed and mixed with a stirrer in water in such an amount that the concentration of the coating components would be 30%, to give compression layer coating composition 5.

### Example 6

The dyed printing substrate of Example 6 was obtained in the same manner as described in Example 1 except that the compression layer coating composition 6 shown below was used instead of compression layer coating composition 1.

### Compression Layer Coating Composition 6

100 parts of synthetic amorphous silica (FINESIL X60: manufactured by Oriental Silicas Corporation), 15 parts of polyvinyl alcohol (PVA235: manufactured by KURARAY CO., LTD.), and 10 parts of an ethylene-vinyl acetate binder (Sumikaflex 401HQ: manufactured by Sumika Chemtex Co., Ltd.) were dispersed and mixed with a stirrer in water in such an amount that the concentration of the coating components would be 15%, to give compression layer coating composition 6.

### Example 7

The dyed printing substrate of Example 7 was obtained in the same manner as described in Example 1 except that the compression layer coating composition 7 shown below was used instead of compression layer coating composition 1.

### Compression Layer Coating Composition 7

100 parts of calcined kaolin (Ansilex 93: manufactured by BASF), 8 parts of starch (MS4600: manufactured by NIHON SHOKUHIN KAKO CO., LTD.), and 16 parts of a styrene-butadiene binder (E1585: manufactured by Asahi Kasei Chemicals Corporation) were dispersed and mixed with a stirrer in water in such an amount that the concentration of the coating components would be 30%, to give compression layer coating composition 7.

### Example 8

The dyed printing substrate of Example 8 was obtained in the same manner as described in Example 1 except that the compression layer coating composition 8 shown below was used instead of compression layer coating composition 1.

### Compression Layer Coating Composition 8

30 parts of calcined kaolin (Ansilex 93: manufactured by BASF), 70 parts of hollow plastic pigment (ROPAQUE HP91: manufactured by Dow Coating Materials), 4 parts of starch (MS4600: manufactured by NIHON SHOKUHIN KAKO CO., LTD.), and 9 parts of a styrene-butadiene binder (E1585: manufactured by Asahi Kasei Chemicals Corporation) were dispersed and mixed with a stirrer in water in such an amount that the concentration of the coating components would be 25%, to give compression layer coating composition 8.

### Example 9

The dyed printing substrate of Example 9 was obtained in the same manner as described in Example 1 except that the compression layer coating composition 9 shown below was used instead of compression layer coating composition 1.

### Compression Layer Coating Composition 9

80 parts of calcined kaolin (Ansilex 93: manufactured by BASF), 20 parts of hollow plastic pigment (ROPAQUE HP91: manufactured by Dow Coating Materials), 6 parts of starch (MS4600: manufactured by NIHON SHOKUHIN KAKO CO., LTD.), and 14 parts of a styrene-butadiene binder (E1585: manufactured by Asahi Kasei Chemicals Corporation) were dispersed and mixed with a stirrer in water in such an amount that the concentration of the coating components would be 25%, to give compression layer coating composition 9.

### Example 10

The dyed printing substrate of Example 10 was obtained in the same manner as described in Example 1 except that the compression layer coating composition 10 shown below was used instead of compression layer coating composition 1.

### Compression Layer Coating Composition 10

30 parts of calcined kaolin (Ansilex 93: manufactured by BASF), 70 parts of hollow plastic pigment (ROPAQUE HP91: manufactured by Dow Coating Materials), 2.5 parts of starch (MS4600: manufactured by NIHON SHOKUHIN KAKO CO., LTD.), and 7.5 parts of a styrene-butadiene binder (E1585: manufactured by Asahi Kasei Chemicals Corporation) were dispersed and mixed with a stirrer in water in such an amount that the concentration of the coating components would be 25%, to give compression layer coating composition 10.

### Example 11

The dyed printing substrate of Example 11 was obtained in the same manner as described in Example 1 except that the compression layer coating composition 11 shown below was used instead of compression layer coating composition 1.

### Compression Layer Coating Composition 11

100 parts of calcined kaolin (Ansilex 93: manufactured by BASF), 10 parts of starch (MS4600: manufactured by NIHON SHOKUHIN KAKO CO., LTD.), and 22 parts of a styrene-butadiene binder (E1585: manufactured by Asahi Kasei Chemicals Corporation) were dispersed and mixed with a stirrer in water in such an amount that the concentration of the coating components would be 30%, to give compression layer coating composition 11.

### Example 12

The dyed printing substrate of Example 12 was obtained in the same manner as described in Example 1 except that a different water-soluble polyester binder (PESRESIN A-613D, glass transition temperature: 54° C., manufactured by Takamatsu Oil & Fat Co., Ltd.) was used instead of the water-soluble polyester binder (PLAS COAT RZ-142, glass transition temperature: 34° C., manufactured by Goo Chemical Co., Ltd.) in the glue layer coating composition.

### Example 13

The dyed printing substrate of Example 13 was obtained in the same manner as described in Example 6 except that the coating weight of the compression layer coating composition was 3 g/m².

### Example 14

The dyed printing substrate of Example 14 was obtained in the same manner as described in Example 6 except that the coating weight of the compression layer coating composition was 5 g/m².

### Example 15

The dyed printing substrate of Example 15 was obtained in the same manner as described in Example 14 except that a woodfree paper having a basis weight of 77 g/m² and a density of 0.65 g/cm³ was used in the base sheet.

### Comparative Example 1

The dyed printing substrate of Comparative Example 1 was obtained in the same manner as described in Example 1 except that a woodfree paper having a basis weight of 77 g/m² and a density of 0.77 g/cm³ was used in the base sheet and no compression layer was formed on the woodfree paper.

### Comparative Example 2

The dyed printing substrate of Comparative Example 2 was obtained in the same manner as described in Comparative Example 1 except that a woodfree paper having a basis weight of 77 g/m² and a density of 0.65 g/cm³ was used in the base sheet.

### Comparative Example 3

The dyed printing substrate of Comparative Example 3 was obtained in the same manner as described in Example 3 except that the coating weight of the compression layer coating composition was 3 g/m².

### Comparative Example 4

The dyed printing substrate of Comparative Example 4 was obtained in the same manner as described in Example 1 except that the compression layer coating composition 12 shown below was used instead of compression layer coating composition 1.

### Compression Layer Coating Composition 12

100 parts of kaolin clay (ULTRA WHITE 90: manufactured by BASF), 5 parts of starch (MS4600: manufactured by NIHON SHOKUHIN KAKO CO., LTD.), and 10 parts of a styrene-butadiene binder (E1585: manufactured by Asahi Kasei Chemicals Corporation) were dispersed and mixed with a stirrer in water in such an amount that the concentration of the coating components would be 50%, to give compression layer coating composition 12.

In Examples 1 to 15 and Comparative Examples 1 to 4, the ability to produce a high-resolution image and color development on the dyed printing substrates, and the adhesiveness of the printed papers were evaluated according to the methods described below. The results are shown in Table 1.

In Examples and Comparative Examples shown above, the drying temperature and drying time after coating were adjusted to obtain predetermined compression ratios as calculated by the formula given below from the smoothness measured using a soft backing at clamp air supply pressures of 300 kPa and 2000 kPa according to JIS P 8151:2004. In Examples and Comparative Examples shown above, after coating and drying of compression layer coating composition, calendering was not performed or soft calendering was performed. In Table 1 shown below, pigment 1 is precipitated calcium carbonate, pigment 2 is synthetic amorphous silica, pigment 3 is calcined kaolin, and pigment 4 is hollow plastic pigment.

Compression ratio=[smoothness of base sheet at 300 kPa]/[smoothness of base sheet at 2000 kPa]

TABLE 1

| | | | Compression layer | | | | | | | | |
|---|---|---|---|---|---|---|---|---|---|---|---|
| | Paper substrate | | Pigment (part by mass) | | | | | | | | |
| | Basis weight (g/m²) | Density (g/m³) | Pigment 1 | Pigment 2 | Pigment 3 | Pigment 4 | Binder (part by mass) | Coating weight (g/m²) | $\frac{Binder}{Pigment}$ | $\frac{Pigment 2 \text{-} 4}{Pigment 1 \text{-} 4}$ | $\frac{Pigment 3 \text{-} 4}{Pigment 1 \text{-} 4}$ |
| Example 1 | 77 | 0.77 | 100 | 0 | 0 | 0 | 10 | 10 | 10% by mass | 0 | 0 |
| Example 2 | 77 | 0.77 | 80 | 20 | 0 | 0 | 10 | 10 | 10% by mass | 20% by mass | 0 |
| Example 3 | 77 | 0.77 | 50 | 25 | 0 | 25 | 10 | 10 | 10% by mass | 50% by mass | 25% by mass |
| Example 4 | 77 | 0.77 | 70 | 0 | 0 | 30 | 10 | 10 | 10% by mass | 30% by mass | 30% by mass |
| Example 5 | 77 | 0.77 | 40 | 0 | 0 | 60 | 10 | 10 | 10% by mass | 60% by mass | 60% by mass |
| Example 6 | 77 | 0.77 | 0 | 100 | 0 | 0 | 25 | 10 | 25% by mass | 100% by mass | 0 |
| Example 7 | 77 | 0.77 | 0 | 0 | 100 | 0 | 24 | 10 | 24% by mass | 100% by mass | 100% by mass |
| Example 8 | 77 | 0.77 | 0 | 0 | 30 | 70 | 13 | 10 | 13% by mass | 100% by mass | 100% by mass |
| Example 9 | 77 | 0.77 | 0 | 0 | 80 | 20 | 20 | 10 | 20% by mass | 100% by mass | 100% by mass |
| Example 10 | 77 | 0.77 | 0 | 0 | 30 | 70 | 10 | 10 | 10% by mass | 100% by mass | 100% by mass |
| Example 11 | 77 | 0.77 | 0 | 0 | 100 | 0 | 32 | 10 | 32% by mass | 100% by mass | 100% by mass |
| Example 12 | 77 | 0.77 | 100 | 0 | 0 | 0 | 10 | 10 | 10% by mass | 0 | 0 |
| Example 13 | 77 | 0.77 | 0 | 100 | 0 | 0 | 25 | 3 | 25% by mass | 100% by mass | 0 |
| Example 14 | 77 | 0.77 | 0 | 100 | 0 | 0 | 25 | 5 | 25% by mass | 100% by mass | 0 |
| Example 15 | 77 | 0.65 | 0 | 100 | 0 | 0 | 25 | 5 | 25% by mass | 100% by mass | 0 |
| Comparative | 77 | 0.77 | 0 | 0 | 0 | 0 | 0 | 0 | — | — | — |
| Example 1 | | | | | | | | | | | |
| Comparative | 77 | 0.65 | 0 | 0 | 0 | 0 | 0 | 0 | — | — | — |
| Example 2 | | | | | | | | | | | |
| Comparative | 77 | 0.77 | 50 | 25 | 0 | 25 | 10 | 3 | 10% by mass | 50% by mass | 25% by mass |
| Example 3 | | | | | | | | | | | |
| Comparative | 77 | 0.77 | 0 | 0 | 100 | 0 | 15 | 10 | 15% by mass | 100% by mass | 25% by mass |
| Example 4 | | | | | | | | | | | |
| | | | | | | | | | Properties of textile printing paper | | |
| | | | | | | | | Base | Ability to | | |
| | | | | | | | | sheet | produce | | |
| | | | | | | | | Com- | a high- | | |
| | | | | | | | | pression | resolution | Color | |
| | | | | | | | | ratio | image | development | Adhesiveness |
| | | | | | | | Example 1 | 1.7 | 2 | 3.84 | 2 |
| | | | | | | | Example 2 | 1.9 | 2 | 4.05 | 2 |
| | | | | | | | Example 3 | 2.3 | 3 | 4.21 | 3 |
| | | | | | | | Example 4 | 2.1 | 3 | 4.18 | 2 |
| | | | | | | | Example 5 | 2.6 | 4 | 4.31 | 3 |
| | | | | | | | Example 6 | 2.4 | 3 | 4.29 | 3 |
| | | | | | | | Example 7 | 2.8 | 4 | 4.39 | 3 |
| | | | | | | | Example 8 | 3.8 | 4 | 4.58 | 3 |
| | | | | | | | Example 9 | 3.3 | 4 | 4.77 | 3 |
| | | | | | | | Example 10 | 4.0 | 4 | 4.41 | 3 |
| | | | | | | | Example 11 | 1.5 | 2 | 3.75 | 2 |
| | | | | | | | Example 12 | 1.7 | 3 | 3.92 | 2 |
| | | | | | | | Example 13 | 1.5 | 2 | 3.77 | 2 |
| | | | | | | | Example 14 | 1.7 | 2 | 3.97 | 2 |
| | | | | | | | Example 15 | 1.9 | 2 | 3.75 | 2 |
| | | | | | | | Comparative | 1.4 | 1 | 3.41 | 1 |
| | | | | | | | Example 1 | | | | |
| | | | | | | | Comparative | 1.6 | 1 | 3.18 | 1 |
| | | | | | | | Example 2 | | | | |
| | | | | | | | Comparative | 1.4 | 2 | 3.68 | 1 |
| | | | | | | | Example 3 | | | | |
| | | | | | | | Comparative | 1.4 | 1 | 3.58 | 1 |
| | | | | | | | Example 4 | | | | |

### Evaluation of Ability to Produce a High-Resolution Image on Dyed Printing Substrates

The transferred test image on each dyed printing substrate was visually evaluated on whether details of the design and letters were sharply depicted. The criteria shown below were used for the evaluation. In the present invention, when the grade was 2 to 4, the ability to produce a high-resolution image was regarded as excellent.

4: Colors in the details are clearly discernible, and the image is very sharp.

3: The image is very sharp.

2: Colors in the details are not clear, but discernible, and the image is generally sharp.

1: Colors in the details are hardly discernible, and the image is unsharp.

### Evaluation of Color Development on Dyed Printing Substrates

The color density of the solid printed area of each of the 3 color inks on each dyed printing substrate was measured using an optical densitometer (X-rite 530, manufactured by SAKATA INX ENG. CO., LTD.). The values of the measured 3 color densities were summed. In the present invention, when the sum of the values was 3.75 or more, color development was regarded as excellent.

### Evaluation of Adhesiveness of Printed Papers

The solid image area of the test image on each printed paper rolled up at ordinary temperature after printing was made to stick to a cotton fabric by heat and pressure application (190° C., 0.5 MPa, 2.5 m/min, on a roller). With the printed paper being stuck on the cotton fabric, fixing treatment was performed by steaming at 100° C. for 15 minutes. After that, the printed paper was released. The image formed on the cotton fabric, which was used as the printing substrate, was visually observed. Based on the degree of color unevenness, adhesiveness was visually evaluated on the criteria shown below. In the present invention, when the grade was 2 or 3, adhesiveness was regarded as excellent.

3: No color unevenness is observed, and image quality is good.

2: Color unevenness is observed but practically acceptable.

1: Color unevenness is observed and practically unacceptable.

As clearly shown in Table 1, in any of Examples 1 to 15, each of which used a base sheet having a compression ratio falling within the range specified in the present invention, the ability to produce a high-resolution image and color development on the printing substrate were good, and the adhesiveness of the printed paper was excellent.

However, none of these effects were observed in the printing substrate obtained in Comparative Example 1 or 2, which used a base sheet without a compression layer of the present invention, or in the printing substrate obtained in Comparative Example 3 or 4, which used a base sheet having a compression ratio falling outside the range specified in the present invention.

In any of Examples 1 to 5, 10 parts by mass of the binder was used relative to 100 parts by mass of the pigment, but the type of the pigment used was different for each Example. The comparison of Example 1 with Examples 2 to 5 shows that a preferable pigment in the compression layer is at least one component selected from the group consisting of synthetic amorphous silica, calcined kaolin and hollow plastic pigment. Moreover, the comparison of Example 2 with Examples 3 to 5 shows that a preferable total percentage of synthetic amorphous silica, calcined kaolin and/or hollow plastic pigment in the pigment is 30% by mass or more.

Regarding the proportion of the binder to the pigment, the comparison of Examples 6 to 10 with Example 11 shows that a preferable proportion of the binder to the pigment in the compression layer is 30% by mass or less.

The comparison of Examples 3 and 5 with Examples 1, 2, 4 and 11 shows that a more preferable case is where the pigment in the compression layer comprises at least one component selected from the group consisting of synthetic amorphous silica, calcined kaolin and hollow plastic pigment; the total percentage of synthetic amorphous silica, calcined kaolin and/or hollow plastic pigment in the pigment is 50% by mass or more; and the proportion of the binder relative to the pigment in the compression layer is 30% by mass or less.

The comparison of Examples 5 and 7 to 10 with Examples 1 to 4 and 11 shows a still more preferable case is where the pigment in the compression layer comprises at least one component selected from the group consisting of calcined kaolin and hollow plastic pigment; the total percentage of calcined kaolin and/or hollow plastic pigment in the pigment is 60% by mass or more; and the proportion of the binder relative to the pigment in the compression layer is 30% by mass or less.

The comparison of Example 1 with Example 12 shows that a preferable glass transition temperature of the water-soluble polyester binder is 51° C. or higher.

### INDUSTRIAL APPLICABILITY

The textile printing paper of the present invention is suitable as a textile printing paper for use in the paper printing method. In addition, the textile printing paper of the present invention can be used also as a textile printing paper for use in transfer printing methods other than the paper printing method.

1. A textile printing paper for use in a paper printing method involving performing dye fixing treatment in such a state that a printed paper is in close contact with a printing substrate, the textile printing paper having a base sheet and a glue layer on a surface of the base sheet, the base sheet having a compression layer on at least a glue layer side, the compression layer at least comprising a pigment and a binder, wherein the base sheet has a compression ratio of 1.5 or more from the smoothness measured using a soft backing at clamp air supply pressures of 300 kPa and 2000 kPa according to JIS P 8151:2004, wherein
Compression ratio=smoothness of base sheet at 300 kPa/(smoothness of base sheet at 2000 kPa).

2. The textile printing paper according to claim 1, wherein the pigment in the compression layer comprises at least one component selected from the group consisting of synthetic amorphous silica, calcined kaolin and hollow plastic pigment.

3. The textile printing paper according to claim 1, wherein the proportion of the binder to the pigment in the compression layer is 30% by mass or less.

4. The textile printing paper according to claim 1, wherein the pigment in the compression layer comprises at least one component selected from the group consisting of synthetic amorphous silica, calcined kaolin and hollow plastic pigment, the total proportion of the at least one component in the pigment is 50% by mass or more, and the proportion of the binder to the pigment is 30% by mass or less.

5. The textile printing paper according to claim 1, wherein the pigment in the compression layer comprises at least one component selected from the group consisting of calcined kaolin and hollow plastic pigment, the total proportion of the at least one component in the pigment is 60% by mass or more, and the proportion of the binder to the pigment is 30% by mass or less.

6. The textile printing paper according to claim 2, wherein the proportion of the binder to the pigment in the compression layer is 30% by mass or less.
